(19) United States
(12) Patent Application Publication
(10) Pub. No.: US 2012/0260283 A1
(43) Pub. Date: Oct. 11, 2012

(54) Associating Interactive Notes with Program Content

(75) Inventor: Sapan Purohit, Denver, CO (US)

(73) Assignee: EchoStar Technologies L.L.C., Englewood, CO (US)

(21) Appl. No.: 13/084,366

(22) Filed: Apr. 11, 2011

(51) Int. Cl. H04N 5/445

(52) U.S. Cl. 725/37

(57) ABSTRACT

A method for allowing a user to interactively take notes while watching program content, the method including the operations of: receiving, at a content receiver, an indication from a remote device, the indication associated with initiation of a note; in response to the indication, providing an input field for a user to input a note; associating the note with the program content; and storing the note in a storage medium along with the association of the note and the program content.

### TECHNICAL FIELD

This disclosure relates generally to interactive programming content, and more specifically to systems and methods for taking and receiving interactive notes during viewing of program content.

### SUMMARY

The present disclosure discloses systems and methods for associating user-generated notes with program content.

One embodiment takes the form of a method for allowing a user to interactively take notes while watching program content, the method including the operations of: receiving, at a content receiver, an indication from a remote device, the indication associated with initiation of a note; in response to the indication, providing an input field for a user to input a note; associating the note with the program content; and storing the note in a storage medium along with the association of the note and the program content.

Another embodiment may take the form of a system for taking interactive notes during a television program, comprising: a set-top box, having a processing unit, a storage unit operatively connected to the processing unit, and a first communications component operatively connected to the processing unit; and a remote device, having at least one input operative to generate an indication that a user wishes to enter a note, at least a second input operative to permit a user to input the note, and a second communications component operatively connected to the at least one input and at least second input, further operative to transmit the indication and the note to the first communications component; wherein the set-top box is configured to receive and process the indication from the remote device, and further configured to receive the note from the remote device.

Still another embodiment may take the form of a method for processing a user-created note, comprising the operations of: receiving the note during display of program content; determining a start time and end time of a segment of the program content; associating the note with the only the segment of the program content; storing the note; and displaying the note during playback of the segment of the program content.

The foregoing general description and the following detailed description are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

FIG. 1 is a block diagram illustrating a system for taking and receiving interactive notes during a television program.

FIG. 2 is a flowchart illustrating a method for allowing a user to interactively take notes while watching a television program, and for the system of FIG. 1 to receive those notes.

FIG. 3 is a diagram illustrating a user utilizing the system of FIG. 1 with a basic remote device.

FIG. 4 is a diagram illustrating a user utilizing the system of FIG. 1 with a tablet computer as the remote device.

FIG. 5 is a diagram illustrating a user inputting a note in accordance with the system of FIG. 1, with the input field displayed on a display device.

FIG. 6 is a diagram illustrating a user inputting a note in accordance with the system of FIG. 1, with the input field displayed on a tablet computer remote device.

### DETAILED DESCRIPTION

The description that follows includes sample systems, methods, and computer program products that embody various elements of the present disclosure. The described disclosure, however, may be practiced in a variety of forms in addition to those described herein.

Program content, such as television programs, including over-the-air, cable and satellite programming, often convey vast amounts of information to their intended audiences. Some programs, for example, teach audience members how to complete do-it-yourself home improvement projects, which stocks to invest in, how to cope with relationship issues, and so forth. The information provided by these programs, while often invaluable, can easily be forgotten if not written down or stored in a safe location. Furthermore, a user watching a particular program may be prompted to take some future action (such as “remodel kitchen using authentic Spanish decor” or “buy a certain stock at some future point in time,” etc.), but may forget to take that action unless reminded later on. Also, a user watching program content may be prompted to take some immediate action, such as to tell a friend about a new product.

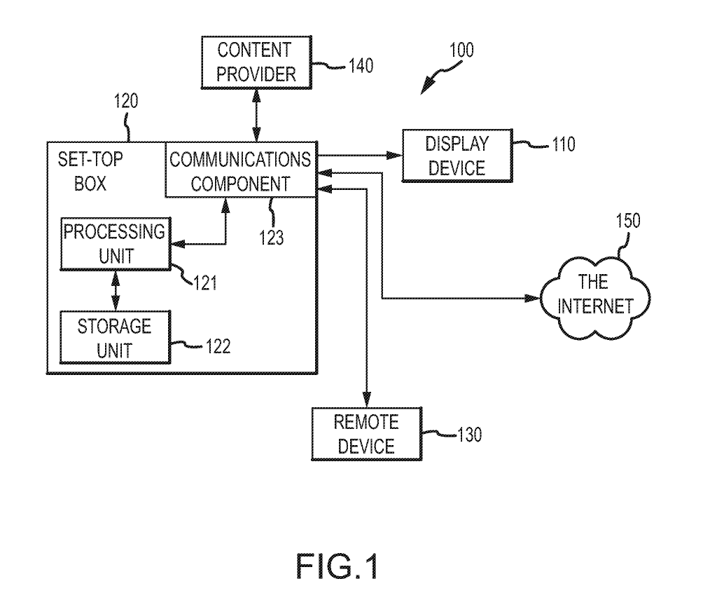

FIG. 1 is a block diagram illustrating a system 100 for taking and receiving interactive notes while viewing program content. (The terms “program content” and “television program” are generally used interchangeably herein.) The system includes a display device 110, a content receiver 120, a remote device 130, and a content provider 140. The display device 110 may be a television, a computer monitor, a cathode ray tube display, a liquid crystal display, or any other device that displays television programming.

The content receiver 120 may be a set-top box associated with a satellite content provider, cable receiver, a desktop computer, a receiving device operating to accept and process program content received over an Internet Protocol or other network connection, or any other electronic device that can receive, process, and transmit television programming and a user's interactive notes. Accordingly, the terms “content receiver” and “set-top box” are used interchangeably in this document, and both are intended to encompass the foregoing. The set-top box 120 may include one or more processing units 121, one or more storage units 122, and a communications component 123. The processing unit may execute instructions, process television content, receive and process a user's notes, and so forth. The one or more storage units 122 may include non-transitory storage media, such as magnetic storage, optical storage, flash memory, and so forth. The communications component 123 may transfer data between the set-top box 120 and the display device 110, between the content provider 140 and the set-top box, and between the set-top box and the remote device 130. In some embodiments, the set-top box may be connected to the Internet 150. In embodiments where the set-top box is connected to the Internet, the communications component 123 may transmit data between the set-top box and the Internet.

The remote device 130 in FIG. 1 may be any of several electronic devices that controls the display device and/or the content receiver 120. For example, a basic remote device may include buttons corresponding with the numbers zero through ten for inputting channel selections. The same numbered buttons may also be used for inputting text, as each numbered button may have one or more letters associated with it. For example, the number ‘2’ button may have letters ‘A,’ ‘B,’ and ‘C’ associated with it, while the number ‘3’ may be associated with the letters ‘D,’ ‘E,’ and ‘F,’ and so forth. A user may enter text using the numbered buttons in a variety of ways. In the example given above, a user may press the number ‘2’ button once to input the letter ‘A,’ or quickly press the number ‘2’ button twice to enter the letter ‘B.’ A basic remote device may further include buttons for volume control, a button to call a menu or programming guide, buttons to navigate in a menu or programming guide, and other various buttons that correspond to different commands from the user.

The remote device 130 in FIG. 1 may alternatively be a more advanced remote control device. For example, the remote device may have a full QWERTY keyboard that allows a user to type text as he or she would on a computer keyboard. The remote may be any type of device that includes a microphone so as to allow a user to input voice notes by simply speaking into the remote. The remote device in FIG. 1 may also be any of a variety of tablet computers, laptop computers, smart phones, e-book readers, and so forth. Such advanced remote devices may have a physical QWERTY keyboard, a touch-screen keyboard, a stylus for the user to digitally ‘write’ on the screen, a microphone for voice input, or any other component that allows a user to input a note, or any combination of the above input components. The remote device 130 in FIG. 1 may also be any other electronic device that communicates with the set-top box 120 and be used for inputting interactive notes.

The remote devices 130 described above may communicate with the set-top box 120 and/or the display device 110 in any appropriate manner. For example, the remote device may transmit commands to the set-top box and/or display device via an infrared or radio frequency transmitter on the remote device and an associated receiver on the set-top box and/or display device. Alternatively, the remote device 130 may transmit and/or receive data via a wireless Ethernet connection shared with the set-top box 120 and/or the display device 110. The wireless Ethernet connection may be, for example, the any of the IEEE 802.11a/b/g/n standards. Alternatively, the remote device may transmit and/or receive data indirectly (not shown in FIG. 1), via, for example, the Internet 150. In these embodiments, the remote device 130 may be wirelessly connected to the Internet while the set-top box maintains a hard-wired connection to the Internet. More generally, any communication protocol may be used to transmit data from the remote device 130 to the set-top box 120 and/or the display device 110, and also to possibly transmit data from the set-top box and/or display device to the remote device.

The content provider 140 in FIG. 1 may take the form of or include any of various over-the-air broadcast providers, cable providers, satellite providers, internet providers, and generally any entity that supplies television programming.

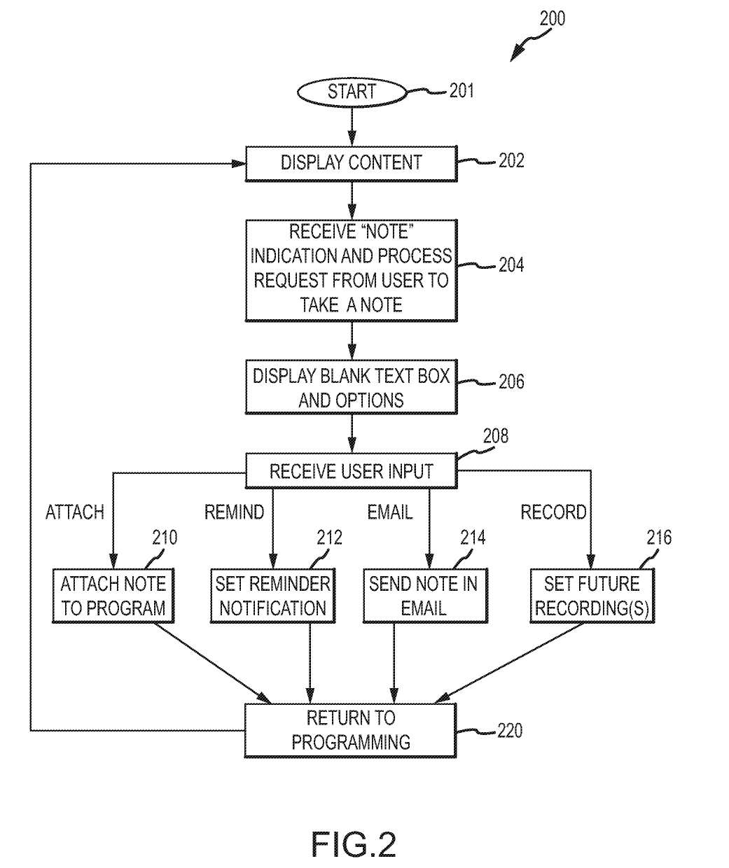

FIG. 2 illustrates a method 200 for allowing a user to interactively take notes while watching a television program, and for the system 100 of FIG. 1 to receive those notes. The flow begins at block 201 and proceeds to block 202 where the set-top box 120 and/or the display device 110 display television programming content to a user until the user indicates a desire to take a note. This indication may be given by, for example, the user selecting a dedicated input (e.g., a button or screen element) on the remote device 130, by the user pressing a menu button on the remote device and selecting “take a note” from a resulting on-display menu, or any other manner. At block 204, the set-top box receives and processes the request from the user. Depending on what type of television programming is currently being displayed, the set-top box may take any of a variety of actions in processing the user's request to take a note. For example, if the television program is being watch by a user at substantially the same time as it is transmitted (e.g., “live”), and is simultaneously stored in the storage unit 122 of the set-top box 120, the set-top box may need take no further action until the user has input the note, after which the set-top box will store the note along with, or as part of, the program currently being recorded, as described below. If the program content is not live but is being played from the storage unit of the set-top box, the set-top box need not take any action until the user has input the note, after which the set-top box will store the note along with the program, as described below. If, however, the user is watching a live television program but the set-top box 120 is not currently recording the program to its storage unit (or it is only temporarily storing the program in its storage unit), the set-top box may begin recording the television program upon receiving a request from the user to record a note.

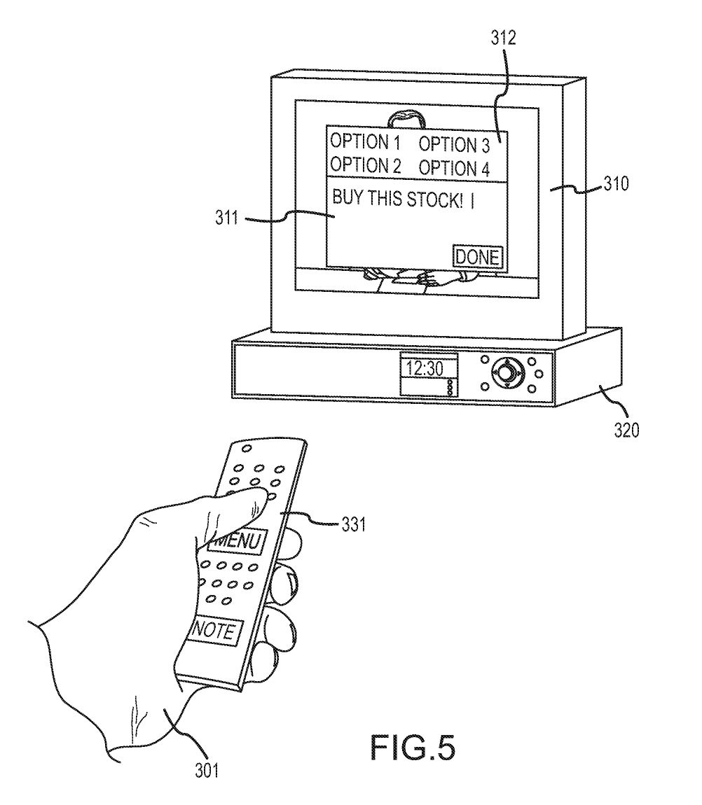

At block 206, the set-top box 120 may provide an input field for the user to take a note, in some cases along with various options related to the note. In some embodiments, a note may be directly entered by a user without prompting or any type of input field. Depending on the type of remote device 130, the input field may be displayed on the display device 110 or on the remote device itself. For example, if the remote device is fairly basic, the input field may be provided on the display device as shown in FIG. 5, and described below. In this case, the set-top box may, by default, pause the television program. This may be done, for example, if the input field obstructs the user's view of the program. Alternately, the set-top box may not automatically pause the program but instead continue to display the program while the user types the note. In either case, the user may be able to bypass the default option at the time of entering the note. For example, if the set-top box automatically paused the television program, the user may be able to resume the program by selecting this from one of the options displayed in the input box. In other embodiments, such as when the remote device 130 is a more complex electronic component (such as a tablet computer), the input field may be provided on the remote device itself. In these embodiments, the set-top box 120 again may or may not pause the television program by default, and the user may be able to override the default option.

Once the system 100 provides an input field for the user to enter a note, the user may enter the note in any of a variety of formats. If the remote device 130 has a physical keyboard, the user may press the physical keys to type the note. If the remote device has a touch-screen keyboard, the user may press the ‘virtual’ keys. If the remote device has a stylus associated with it, the user may ‘write’ the note. If the remote device has a microphone, the user may speak the note. In the case of inputting a voice or spoken note, the device may filter out background noise such as the television programming, if it was not paused. Such filtering may be processed by software, hardware, or some combination of software and hardware.

As part of, or along with, the input field, the system 100 may provide the user with any number of different options. As described above, the user (or system) may pause or un-pause the television programming. The user may also be presented with options for where to store the note. The note may be stored, for example, with the program currently being displayed and/or recorded to the set-top box's 120 storage unit 122. In these embodiments, the note may be stored as metadata with the program, or may be stored separately on the set-top box's storage unit and, optionally, linked to or associated with the program content. Also in these embodiments, the user may be given the option to associate a start and/or end time of a segment of the program content with the note. For example, the user may wish to have a particular note associated with a segment of the program content starting 12 minutes into the content and ending 16 minutes into the content, and another note associated with the program segment running between minutes 22 and 24 of the program content. The user may be able to associate a note with an entire program. The set-top box 120 may provide a default start and stop time associated with the note. For example, the set-top box may determine that the start time associated with the note is the time when the user started typing the note. Alternately, the start time associated with the note can be the starting time of the program content, or a starting time of a particular segment or portion of the program content. Metadata and/or other markers (such as markers indicating the presence of a commercial) may be used to determine the default start and/or end time of a particular note. As one example, the set-top box 120 may associate a note with a segment of the program bounded by commercials on either end, or a segment having a start and end marked by metadata. If in fact the set-top box sets a default start and/or stop time, the user may override these defaults and select an appropriate start and stop time.

Another option that may be presented to the user is to be able to store the note as a reminder notification. For example, the user may wish to be notified 24 hours after storing the note to accomplish some task. One of the options presented to the user may allow the user to set such a reminder in the set-top box 120. Furthermore, the user may be presented with different options of how to send the reminder at the appropriate time, such as displaying a reminder on the display device 110 at the designated time, sending an e-mail or text message containing the note at the designated time, activating or deactivating the content receiver, display or another device, setting a time at which a telephone call is initiated by the content receiver, and so on. Another option the user may be presented with when inputting a note is the option to take some immediate action, such as to send the note immediately in an email message to someone. A segment of the program content associated with the note may be sent with or in the email. Yet another option may be to set a future recording of some show in connection with inputting the note. For example, the set-top box may process the text or audio of the note to extract any names of program content and times, and create a recording timer based on such information. Other data, such as actor names and the like, may also be used. These and many other options may be presented to the user alone, or in combination with one another.

Returning to block 206, once the input field and/or options are provided to the user, the system 100 waits for the user input, and once the system receives the user input in block 208, flow proceeds to block 210, 212, 214, 216, or some combination of those blocks. If, for example, the user selected the option of attaching the note to a program being recorded on the set-top box's 120 storage unit 122, flow proceeds to block 210, where the system stores the note with the program on the storage unit as per the user's various options If the user note instructs the content receiver to set a reminder, then operation 212 may be accessed and a reminder notification created for display at a particular time by the content receiver. As one example, the notification may pop up or otherwise be displayed on the display at the appropriate time. If, instead, the note is a reminder to the user to record particular program content (or an instruction to the content receiver to record particular content), operation 216 is executed in which the content receiver creates a recording timer. As yet another option, the user may select an option to email the note (and, optionally, some portion of the program content associated therewith), in which case operation 214 is accessed and the content receiver generates and transmits the requested email. Alternative embodiments may have additional functionality associated with a particular note beyond those specifically shown in FIG. 2 and described herein.

Following any of operations 210, 212, 214 and 216, flow proceeds to block 220 where the system closes the input field and returns to the television programming. Flow then proceeds back to block 202, where the display device 110 continues to display the television programming until it receives another indication from the user desiring to take a note.

Depending on how and where the note has been stored, and the options the user selected when inputting the note, the set-top box 120 may do several different things. For example, if the note was stored with a program on the set-top box's storage unit 122, the set-top box may include an indication to the user that a particular recorded program has notes associated with it. This may be implemented by displaying a small icon of a piece of paper next to any recorded program with notes in a list of recorded programs available for the user to watch. In other embodiments, the set-top box may scan the notes inputted by the user, and based on the content of those notes, provide targeted ads, or suggest targeted content for the user to purchase.

Notes may be displayed when associated program content (or particular portions of program content) are replayed from the storage medium. Alternately, if the note specifies a particular time for a reminder, the note may be displayed at the time and/or date specified in the note.

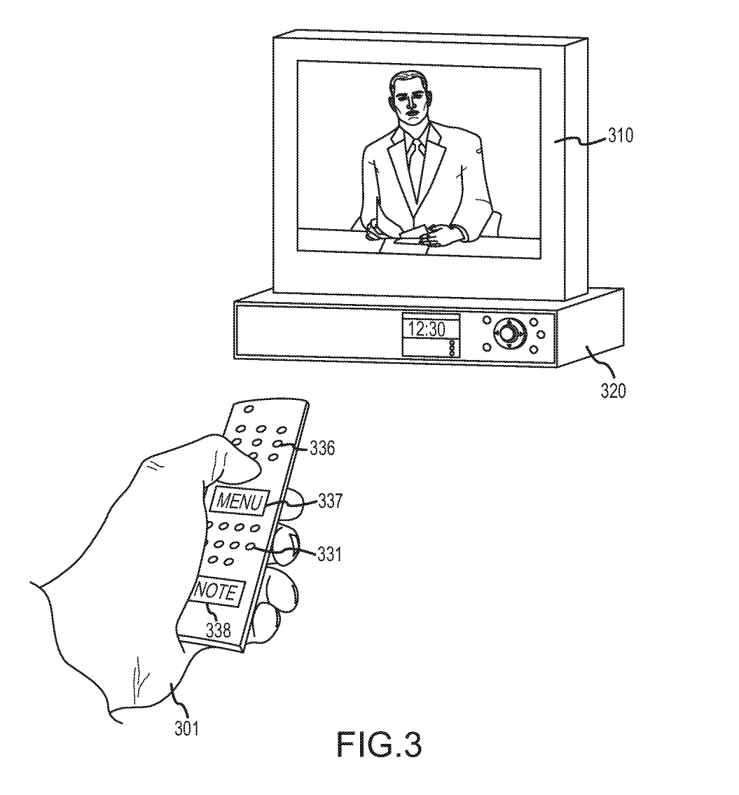

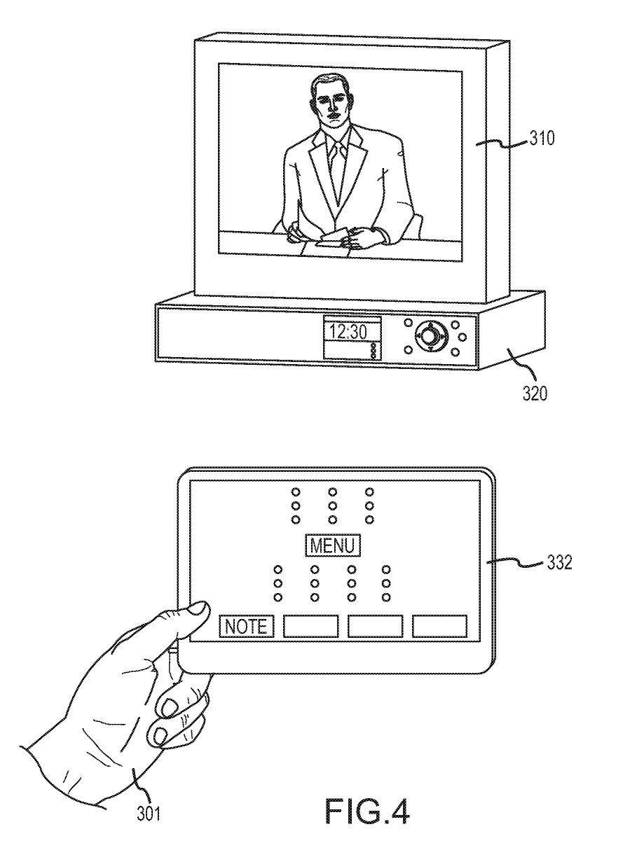

FIGS. 3 to 6 illustrate a user 301 utilizing various embodiments of the system 100 described above. FIG. 3 shows a user holding a basic remote device 331 that has buttons corresponding to the numbers zero through ten 336, a menu button 337, and a note button 338. The basic remote device may transmit commands to the set top box 320 via infrared signals. The set-top box transmits data to the display device 310, which in FIG. 3 is a television. FIG. 4 is similar to FIG. 3, except that FIG. 4 shows a user 301 holding a more advanced remote device 332.

FIG. 5 shows a user 301 holding a basic remote device 331, with an input field 311 and option fields 312 displayed on the display device 310. As the user presses the buttons on the basic remote device, the note is transmitted from the remote device, to the set-top box, and is visible in the input field 331 on the display device 310.

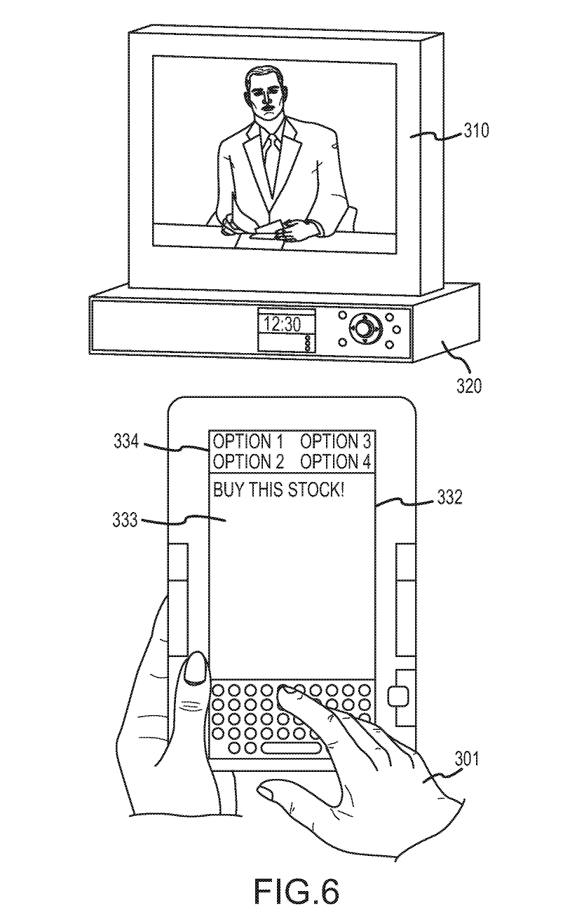

FIG. 6 shows a user 301 typing a note on a more advanced remote device 332. In this figure, the input field 333 and option fields 334 are provided on the remote device itself, rather than on the display device 310.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

It should be appreciated that any note stored with, or associated with, stored program content may be used to index and/or search program content. That is, different program content may be grouped together based on the content of their associated notes. Such grouped program content may be displayed to a user as a group. As one example, a user may view a folder containing all program content having a particular word present in the associated notes. Further, a user may search the notes to retrieve all program content associated with those notes matching the search term. In this manner, a user may customize storage and/or indexing of program content based on the notes he enters.

In still other embodiments, the notes may be stored at a cable headend or satellite transmission facility in addition to, or instead of, at the content receiver. In still other embodiments, notes may be stored in the remote. Such storage options may permit a user to retrieve notes even in the event that the storage medium of the content receiver fails.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to several embodiments, these embodiments are illustrative only, and the scope of the disclosure is not limited to them. Many variations, modifications, additions, and improvements are possible. More generally, embodiments in accordance with the present disclosure have been described in the context of particular embodiments. Functionality may be separated or combined in blocks differently in various embodiments of the disclosure or described with different terminology. These and other variations, modifications, additions, and improvements may fall within the scope of the disclosure as defined in the claims that follow.

1. A method for allowing a user to interactively take notes while watching program content, the method comprising:
receiving, at a content receiver, an indication from a remote device, the indication associated with initiation of a note;
in response to the indication, providing an input field for a user to input a note;
associating the note with the program content; and
storing the note in a storage medium along with the association of the note and the program content.

2. The method of claim 1, wherein the note is associated with a segment of the program content defined by a start time and an end time, the segment less than a total of the program content.

3. The method of claim 2, wherein at least one of the start time and end time is automatically determined by the content receiver based on metadata associated with the program content.

4. The method of claim 1, further comprising the operation of generating a reminder notification based on the note.

5. The method of claim 4, further comprising the operation of providing an alert at a time specified in the reminder notification.

6. The method of claim 5, wherein the alert is provided by text message.

7. The method of claim 1, further comprising the operations of:
generating an email message based on the note; and
transmitting the email message to a recipient associated with the note.

8. The method of claim 1, wherein the remote device comprises a tablet computing device.

9. The method of claim 1, wherein the operation of storing the note in a storage medium along with the association of the note and the program content comprises:
rendering the note as program content metadata; and
storing the program content metadata with the program content, such that the program content metadata is retrieved when the program content is retrieved.

10. The method of claim 1, wherein targeted content is delivered to the user based on the content of the note.

11. A system for taking interactive notes during a television program, comprising:
a set-top box, comprising:
a processing unit;
a storage unit operatively connected to the processing unit; and
a first communications component operatively connected to the processing unit; and
a remote device, comprising:
at least one input operative to generate an indication that a user wishes to enter a note;
at least a second input operative to permit a user to input the note;
a second communications component operatively connected to the at least one input and at least second input, further operative to transmit the indication and the note to the first communications component; wherein
the set-top box is configured to receive and process the indication from the remote device, and further configured to receive the note from the remote device.

12. The system of claim 11, wherein the storage unit is configured to store the note.

13. The system of claim 12, wherein the processing unit is operative to associate the note with the program content.

14. The system of claim 13, wherein the processing unit is operative to associate the note with a particular segment of the program content, the segment automatically determined by the processing unit.

15. The system of claim 14, wherein the segment is based on a start and end time at which the note is inputted via the at least second input.

16. The system of claim 14, wherein the segment is based on metadata associated with the program content.

17. The system of claim 14, wherein the segment is based on a content of the note.

18. The system of claim 11, wherein:
the note comprises an email request; and
the processing unit is operative to generate an email based on the note.

19. The system of claim 18, wherein the processing unit is further operative to associate a program segment with the note.

20. A method for processing a user-created note, comprising:
receiving the note during display of program content;
determining a start time and end time of a segment of the program content;
associating the note with the only the segment of the program content;
storing the note; and
displaying the note during playback of the segment of the program content.
